(19) United States
(12) Patent Application Publication
(10) Pub. No.: US 2003/0034105 A1
(43) Pub. Date: Feb. 20, 2003

(54) Device for transferring pressurized air

(76) Inventor: Edward J. McBride, Colorado Springs, CO (US)

Correspondence Address: Law Offices of Dale B. Halling, Suite 311, 24 South Weber St., Colorado Springs, CO, 80903, US

(21) Appl. No.: 09/929,601

(22) Filed: Aug. 14, 2001

(51) Int. Cl. B60C 23/10

(52) U.S. Cl. 152/415

(57) ABSTRACT

A device for transferring the pressurized fluid (gas) from one vessel to another vessel consists of a tube having a first end and a second end. A first connector is attached to the first end of the tube. A second connector is attached to the second end of the tube. This device allows a bicyclist to transfer pressurized air from the full tire to the flat tire.

### FIELD OF THE INVENTION

The present invention relates generally to the field of devices for pressurizing a tire or other vessel and more particularly to a device for transferring pressurized air from a first container to a second container.

### BACKGROUND OF THE INVENTION

Bicyclists commonly carry a patch in case of a flat tire. The patch is applied to the tube of the tire and a small hand pump is used to fill the tire. Unfortunately, the small hand pumps are slow to pump up tires, add extra weight to the bicycle and fall out of their mounts. Motorcyclists and motorists face a similar situation. Most motorcycles do not have a spare, but simple field patches do exist for motorcycle tires. Unfortunately, it does not do the riders any good to fix the hole without an air source to pressurize their tire. Cars commonly have a spare tire, but changing a spare tire on a busy road is dangerous and dirty work. Thus there exists a need for device that can easily and inexpensively provide needed air pressure to flat tires.

### BRIEF DESCRIPTION OF THE DRAWINGS

FIG. 1 is a drawing of a device for transferring pressurized air being used on a bicycle in accordance with one embodiment of the invention;

FIG. 2 is a semi exploded view of a device for transferring pressurized air in accordance with one embodiment of the invention; and

FIG. 3 is a perspective view of a device for transferring pressurized air in accordance with one embodiment of the invention.

### DETAILED DESCRIPTION OF THE DRAWINGS

A device for transferring the pressurized fluid from one vessel to another vessel consists of a tube having a first end and a second end. A first connector is attached to the first end of the tube. A second connector is attached to the second end of the tube. This device allows a bicyclist to transfer pressurized air from a full tire to the flat tire. The bicyclist may also transfer pressurized air from a car tire. The device allows the user to quickly and easily fill the flat tire. In emergency situations the device allows the user to quickly provide enough air pressure to get back to the car or a service station. For the bicyclists the small size and light weight of the device is a major advantage and anything that added weight and size would seriously detract from the usefulness of the device.

If an automobile tire has a slow leak in a tire, the device can be used to easily provide the air pressure necessary to get to a service station. This reduces the problems associated with attempting to change a tire on a busy street or highway.

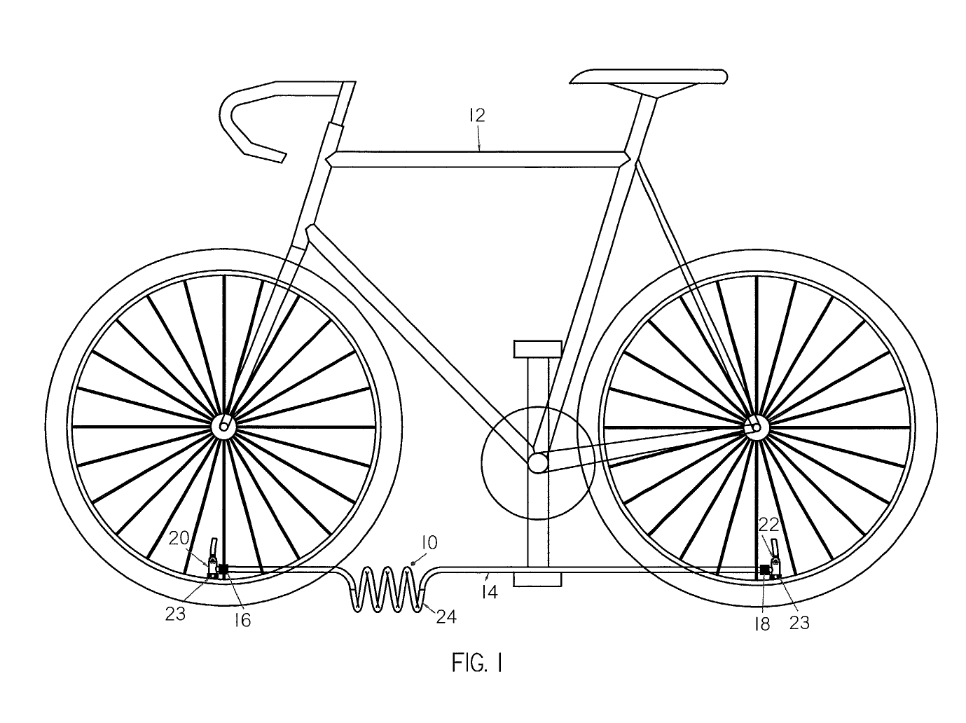

FIG. 1 is a drawing of a device 10 for transferring pressurized air being used on a bicycle 12 in accordance with one embodiment of the invention. The device 10 has a tube (flexible pipe) 14 having a first end 16 and a second end 18. A first connector (first coupler) 20 is attached to a first end 16 of the tube 14. A second connector (second coupler) 22 is attached to a second end 18 of the tube 14. The first connector 20 and second connector 22 may be a latching pump head connector for quick attachment to the valve stems (inlet/outlet) 23 of tires. The connectors 20, 22 shown in FIG. 1 are latching pump head connectors, however the invention is not limited to this type of connector. The device 10 allows the user to transfer pressurized air from a full tire to a flat tire quickly and easily. The device 10 is simple to make and is lightweight and small. These are especially important features for bicyclists. In one embodiment of the invention the tube is flexible and includes a flexible spiral (flexible memory spiral) 24. The flexible spiral allows the device to be stretched between the flat and the air source. Once the device has been used the flexible spiral 24 causes the device 10 to contract to a convenient compact carrying shape.

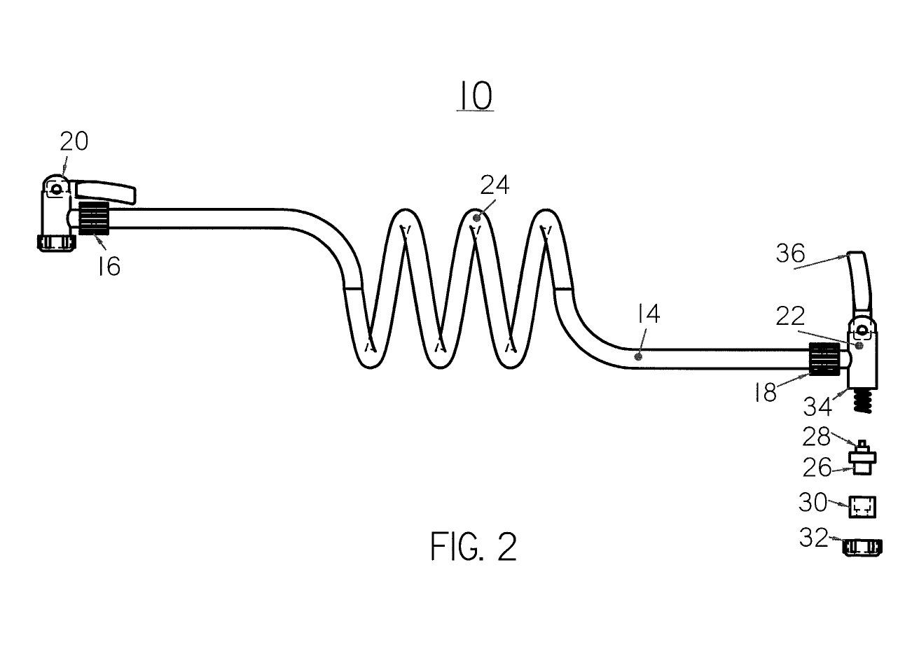

FIG. 2 is a semi exploded view of a device 10 for transferring pressurized air in accordance with one embodiment of the invention. Note that the same reference numeral will be used throughout the drawings to designate the same element. The device 10 in FIG. 2 is the same as in FIG. 1 but shows an exploded view of one of the connectors 22. This embodiment of the connector 22 is capable of latching to both of the most common valve types used on bicycles. As a result it can attach to either a schrader valve or a presta valve. A schrader valve has a pin that must be depressed to allow air to be removed or injected into the tire (tube). In order to depress this pin an insert 26 has a tip 28 that is designed to depress the pin when the latching pump head is attached to a schrader valve. Note that the insert must be reversed from its position in the drawing for a schrader valve. A fitting 30 sits on top of the insert 26 and a threaded cap 32 fits over the fitting and screws onto an end 34 of the connector 22. The latching pump head 22 is attached to the valve stem by depressing the handle 36, which pushes the tip 28 against the pin of the valve. In other embodiments the latching pump head is activated by extending the handle 36. When the insert 26 is in the position shown in the drawing the latching pump head connector 22 is designed to attach to a presta valve. Thus by reversing the insert's direction the connector can accommodate both valve types. The latching pump head 22 shown here is commercially available from manufacturers such as TREK (Part No. 54307). Note that the tube is an airtight hose and the attachment of the connector to the tube forms an airtight seal. In this embodiment, a portion of the tube forms a flexible spiral.

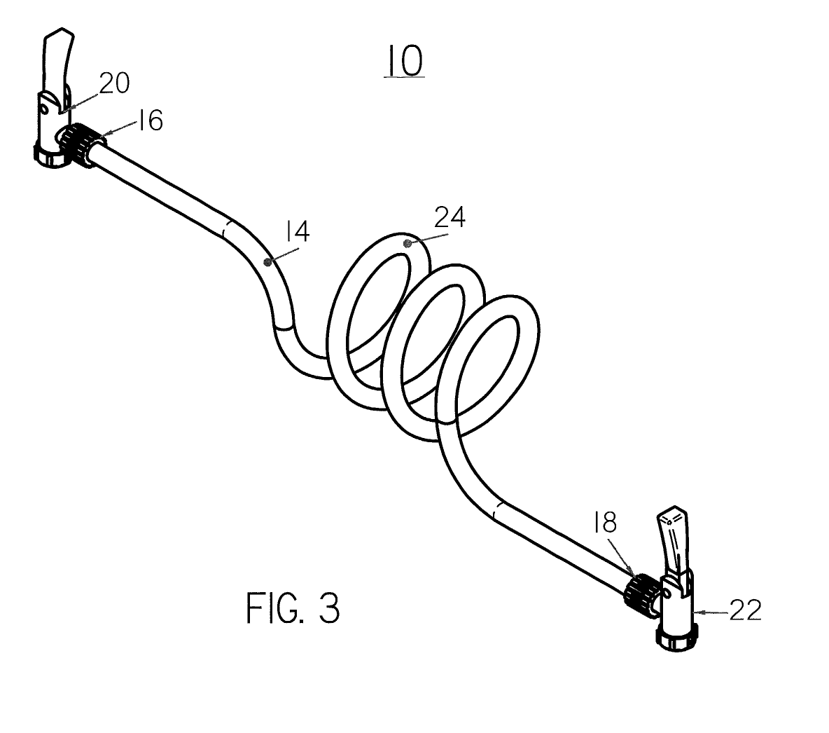

FIG. 3 is a perspective view of a device 10 for transferring pressurized air in accordance with one embodiment of the invention. FIG. 3 is the same as FIG. 2 except that one of the connectors is not exploded. Note that this device allows you to attach one connector to a schrader valve and the other connector to a presta valve. For bicyclist this can be useful when the bicycle has a presta valve and they are drawing air from a car or motorcycle or bicycle tire with a schrader valve.

The device has a number of uses in addition to those described for bicycles. One use is when an automobile has a tire with a slow leak, air pressure can be transferred from one tire (vessel, air bladder, first container) to the flat tire. This allows the user to drive to a service station to have the tire fixed. The user does not have to change the tire on the side of the road which is often dangerous, tiring and result in the user becoming dirty.

Another use of the device is to fill devices such as air mattresses. One end can be connected to an automobile tire and the other end to an air mattress. Or the device can be used to fill a tire of a mountain bike that is low. For all these uses the small size and lightweight and ease of use of the device are important.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A device for transferring the pressure from one vessel to another vessel, comprising:
a tube having a first end and a second end;
a first connector attached to the first end of the tube; and
a second connector attached to the second end of the tube.

2. The device of claim 1, wherein the first connector is a latching pump head.

3. The device of claim 2, wherein the latching pump connector is capable of attaching to a schrader valve.

4. The device of claim 2, wherein the latching pump connector is capable of attaching to a presta valve.

5. The device of claim 1, wherein the tube is flexible.

6. The device of claim 1, wherein the tube forms an airtight hose.

7. The device of claim 1, wherein the first connector is attached to the tube and forms an airtight seal.

8. The device of claim 1, wherein a portion of the tube forms a flexible spiral.

9. A device for transferring pressurized air from a first container to a second container, consisting essentially of:
a flexible pipe having a first end and a second end;
a first connector attached to the first end of the flexible pipe, the first connector designed to connect to a first container connector; and
a second connector attached to the second end of the flexible pipe, the second connector designed to connect to a second container connector.

10. The device of claim 9, wherein the second connector is a latching pump head.

11. The device of claim 9, wherein the second connector is capable of attaching to a schrader valve.

12. The device of claim 9, wherein the second connector is capable of attaching to a presta valve.

13. A device for transferring pressurized gas from a first air bladder to a second air bladder, consisting of:
a tube having a first end and a second end;
a first coupler attached to a first end of the tube, the first coupler designed to couple to an inlet/outlet of the first air bladder;
a second coupler attached to a second end of the tube, the second coupler designed to couple to an inlet/outlet of the second air bladder.

14. The device of claim 13, wherein the tube has a flexible memory spiral along a portion of a length of the tube.

15. The device of claim 13, wherein the first coupler is attached to schrader valve and the second coupler is attached to presta valve.
